(19) United States
(12) Patent Application Publication
(10) Pub. No.: US 2014/0132586 A1
(43) Pub. Date: May 15, 2014

(54) DISPLAY APPARATUS AND CONTROL METHOD THEREOF

(71) Applicant: SAMSUNG ELECTRONICS CO., LTD., Suwon-si (KR)

(72) Inventor: Tae-soon PARK, Hwaseong-si (KR)

(21) Appl. No.: 13/944,121

(22) Filed: Jul. 17, 2013

(30) Foreign Application Priority Data
Nov. 9, 2012 (KR) 10-2012-0126674

(51) Int. Cl. G09G 5/00

(52) U.S. Cl. CPC G09G 5/001
USPC 345/212

(57) ABSTRACT

A display apparatus including: a self-luminous display panel; an image processor which processes an image signal and displays an image on the display panel based on the processed image signal; and a controller which performs a reset operation to remove remaining electrons from the panel by discharging the panel at a preset interval while the image is displayed, and selectively performs a first reset operation and a second reset operation based on image information quantity of frames of the image displayed on the panel, wherein the first reset operation is performed to discharge the entire panel and the second reset operation is performed to sequentially discharge divided areas, into which the panel is divided, at the preset interval.

### CROSS-REFERENCE TO RELATED APPLICATION

This application claims priority from Korean Patent Application No. 10-2012-0126674, filed on Nov. 9, 2012 in the Korean Intellectual Property Office, the disclosure of which is incorporated herein by reference.

### BACKGROUND

1. Field

Apparatuses and methods consistent with the exemplary embodiments relate to a display apparatus and a control method thereof which processes an image signal and displays an image based on the processed image signal, and more particularly, to a display apparatus and a control method thereof which drives a self-luminous display panel such as a plasma display panel (PDP) to prevent a contrast of an image displayed on the PDP from being decreased when the PDP is used.

2. Description of the Related Art

A display apparatus processes an image signal supplied by an external image supply source and displays an image on a display panel such as a liquid crystal display (LCD) panel based on the processed image signal. The display apparatus scans to the display panel scanning lines including image information to display an image on the display panel. The scanned scanning lines are sequentially arranged in the panel to form a single image frame. The display panel of the display apparatus may be implemented as various display types including a liquid crystal display (LCD) panel, a plasma display panel (PDP), etc., and used in various display apparatuses.

The display panel of the display apparatus may be classified as a light receiving panel or a self-luminous panel depending on a light generating method. The light receiving panel does not emit light by itself, and thus includes a backlight unit which generates and emits light to the panel. An example of the light receiving panel includes an LCD panel. The self-luminous panel emits light by itself and does not need any backlight unit. An example of the self-luminous panel includes an organic light emitting diode (OLED) panel and a PDP panel.

Among the self-luminous display panels, the PDP displays an image by using the electro-discharge of plasma. The PDP panel is formed by arranging a gas tube between two glass plates, and neon or argon is injected to the gas tube. Voltage is applied to electrodes connected to the gas tube to induce a plasma phenomenon. Such a phenomenon generates ultraviolet rays, which transmit fluorescent layers in RGB colors of the PDP panel and are converted into visible rays to display color images.

When an image frame is displayed on the PDP, there is a remainder of electrons which were not used in displaying the image frame. The remaining electrons may adversely affect a picture quality when a next frame is displayed. Thus, the PDP periodically discharges the entire panel to remove the remaining electrons.

### SUMMARY

The foregoing and/or other aspects may be achieved by providing a display apparatus including: a self-luminous display panel; an image processor configured to process an image signal and display an image on the display panel based on the processed image signal; and a controller configured to perform a reset operation which removes remaining electrons from the display panel by discharging the display panel at a preset interval while the image is displayed, and selectively perform a first reset operation and a second reset operation depending on image information quantity of frames of the image displayed on the display panel, wherein the first reset operation is performed to discharge the entire panel and the second reset operation is performed to sequentially discharge divided areas, into which the display panel is divided, at the preset interval.

According to an aspect of the exemplary embodiment, the controller may select one of the first reset operation and the second reset operation based on the image information quantity of the frame that is displayed in real-time.

According to another aspect of the exemplary embodiment, the controller may select the first reset operation if the image information quantity of the frame is higher than a preset level, and may select the second reset operation if the image information quantity of the frame is lower than the preset level.

According to another aspect of the exemplary embodiment, the image information quantity of the frame may include an average picture level (APL) of the frame.

According to another aspect of the exemplary embodiment, the controller may divide the panel into a unit of a horizontal pixel line of the panel.

According to another aspect of the exemplary embodiment, the controller may classify the panel into a first area including the horizontal pixel line in odd lines and a second area including the horizontal pixel line in even lines, and may sequentially discharge the first and second areas when performing the second reset operation.

According to another aspect of the exemplary embodiment, the controller may adjust the preset interval for performing the first reset operation based on the image information quantity of the frame.

According to another aspect of the exemplary embodiment, the controller may perform the second reset operation if the image information quantity is smaller than a preset level, and may extend the interval and performs the first reset operation if the image information quantity is larger than the preset level.

According to an aspect of the exemplary embodiment, the panel may include a plasma display panel (PDP).

According to another aspect of the exemplary embodiment, a control method of a display apparatus includes a self-luminous display panel. The control method includes: processing an image signal and displaying an image on the panel based on the processed image signal; performing a reset operation to remove remaining electrons from the panel by discharging the panel at a preset interval while the image is displayed; wherein the performing the reset operation includes selectively performing one of a first reset operation and a second reset operation based on image information quantity of frames of the image displayed on the panel, wherein the first reset operation is performed to discharge the entire panel, and the second reset operation is performed to sequentially discharge divided areas of the panel at the preset interval.

According to an aspect of the exemplary embodiment, the selectively performing one of the first reset operation and the second reset operation may include selecting one of the first reset operation and second reset operation depending on the image information quantity of the frame that is displayed in real-time.

According to an aspect of the exemplary embodiment, the selectively performing one of the first reset operation and second reset operation may include selecting the first reset operation if the image information quantity of the frame is higher than a preset level, and selecting the second reset operation if the image information quantity of the frame is lower than the preset level.

According to an aspect of the exemplary embodiment, the image information quantity of the frame may include an average picture level (APL) of the frame.

According to an aspect of the exemplary embodiment, the selectively performing one of the first reset operation and second reset operation may include dividing the panel into a unit of a horizontal pixel line of the panel.

According to an aspect of the exemplary embodiment, the dividing the panel into the unit of horizontal pixel line of the panel may include classifying the panel into a first area including the horizontal pixel line in odd lines and a second area including the horizontal pixel line in even lines; and sequentially discharging the first and second areas when performing the second reset operation.

According to an aspect of the exemplary embodiment, the dividing the panel into the unit of horizontal pixel line of the panel may include adjusting the preset interval for performing the first reset operation based on the image information quantity of the frame.

According to an aspect of the exemplary embodiment, the dividing the panel into the unit of horizontal pixel line of the panel may further include performing the second reset operation if the image information quantity is smaller than a preset level, and the adjusting the preset interval for performing the first reset operation includes extending the preset interval and performing the first reset operation if the image information quantity is larger than the preset level.

According to an aspect of the exemplary embodiment, the panel may include a PDP.

According to another aspect of the exemplary embodiments, a display apparatus includes: a self-luminous display panel; an image processor configured to process an image signal and display an image on the panel based on the processed image signal; and a controller configured to analyze image information quantity of a frame of the image displayed in real-time, discharge the entire panel at a predetermined interval to reset remaining electrons of the panel if it is determined that the image information quantity of the frame is larger than a preset level, and sequentially discharge a plurality of display areas forming the panel at the predetermined interval, rather than the entire panel, if it is determined that the image information quantity is smaller than the preset level.

According to an aspect of the exemplary embodiment, the panel may include a plasma display panel (PDP).

### BRIEF DESCRIPTION OF THE DRAWINGS

The above and/or other aspects will become apparent and more readily appreciated from the following description of the exemplary embodiments, taken in conjunction with the accompanying drawings, in which:

FIG. 1 is a block diagram of a display apparatus according to an exemplary embodiment;

FIG. 2 is a schematic sectional view of a display panel used in the display apparatus in FIG. 1;

FIG. 3 is a block diagram of a driving structure for the display panel in FIG. 2;

FIG. 4 illustrates an example of a method of expressing a gray level of a single image frame by 8 sub-fields in the display apparatus in FIG. 1;

FIGS. 5 and 6 are examples of a method of performing a reset operation while an image displayed in the display apparatus in FIG. 1; and

FIG. 7 is a control flowchart of a control method of the display apparatus in FIG. 1.

### DETAILED DESCRIPTION OF EXEMPLARY EMBODIMENTS

Below, exemplary embodiments will be described in detail with reference to accompanying drawings so as to be easily realized by a person having ordinary knowledge in the art. The exemplary embodiments may be embodied in various forms without being limited to the exemplary embodiments set forth herein. Descriptions of well-known parts are omitted for clarity, and like reference numerals refer to like elements throughout.

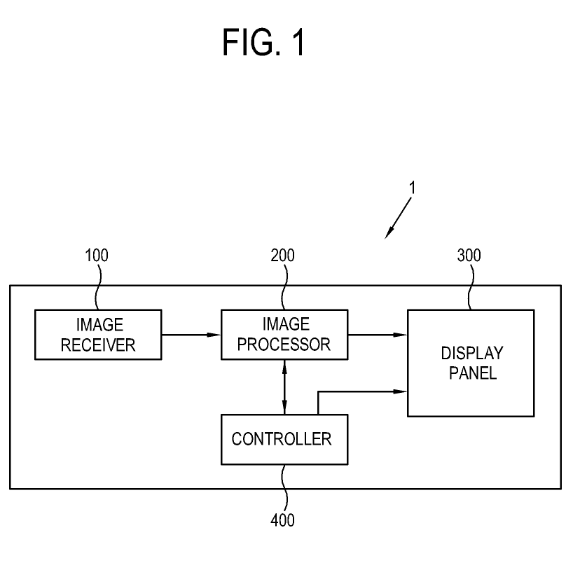

FIG. 1 is a block diagram of a display apparatus 1 according to an embodiment.

As shown in FIG. 1, the display apparatus 1 according to the present exemplary embodiment includes an image receiver 100 which receives an image signal from an external source, an image processor 200 which processes the image signal received by the image receiver 100, a display panel 300 which displays an image thereon based on the image signal processed by the image processor 200, and a controller 400 which controls overall operations of the display apparatus 1.

The display apparatus 1 according to the present exemplary embodiment may apply to any type of devices which process image signals/image data and display an image, such as a television (TV), a computer monitor, a portable multimedia player (PMP), a mobile phone, etc., but not limited thereto.

Hereinafter, a configuration of the display apparatus 1 will be described in detail.

The image receiver 100 receives image signals/image data from an image supply source and transmits the signals/data to the image processor 200. The image receiver 100 may be provided as various types corresponding to a standard of a received image signal and an exemplary type of the display apparatus 1. For example, the image receiver 100 may receive radio frequency (RF) signals in a wireless manner from a broadcasting station (not shown), or receive image signals in a wired manner according to standards such as composite video, component video, super video, SCART, high definition multimedia interface (HDMI), DisplayPort, unified display interface (UDI) or wireless HD.

The image receiver 100 may receive image data through a local connection such as a Universal Serial Bus (USB) or receive image data packet from a server (not shown) through a network. If the image signal is a broadcasting signal, the image receiver 100 includes a tuner to tune the broadcasting signal per channel.

The image processor 200 performs various image processing operations with respect to the image signal received by the image receiver 100. The image processor 200 outputs the processed image signal to the display panel 300, on which an image is displayed on the basis of the image signal.

The image processing operation of the image processor 200 may include, but not limited to, a decoding operation corresponding to image formats of image data, a de-interlacing operation for converting interlace image data into progressive image data, a scaling operation for adjusting image data into preset resolution, a noise reduction operation for improving an image quality, a detail enhancement operation, a frame refresh rate conversion, etc.

The image processor 200 may be implemented as a system-on-chip (SoC) which performs integrated functions or as an image processing board (not shown) that is formed by installing individual groups independently performing the foregoing operations on a printed circuit board (PCB) and then is installed in the display apparatus 1.

The display panel 300 displays an image thereon based on the image signal output by the image processor 200. The display panel 300 according to the present exemplary embodiment includes a self-luminous panel and is implemented as a PDP panel.

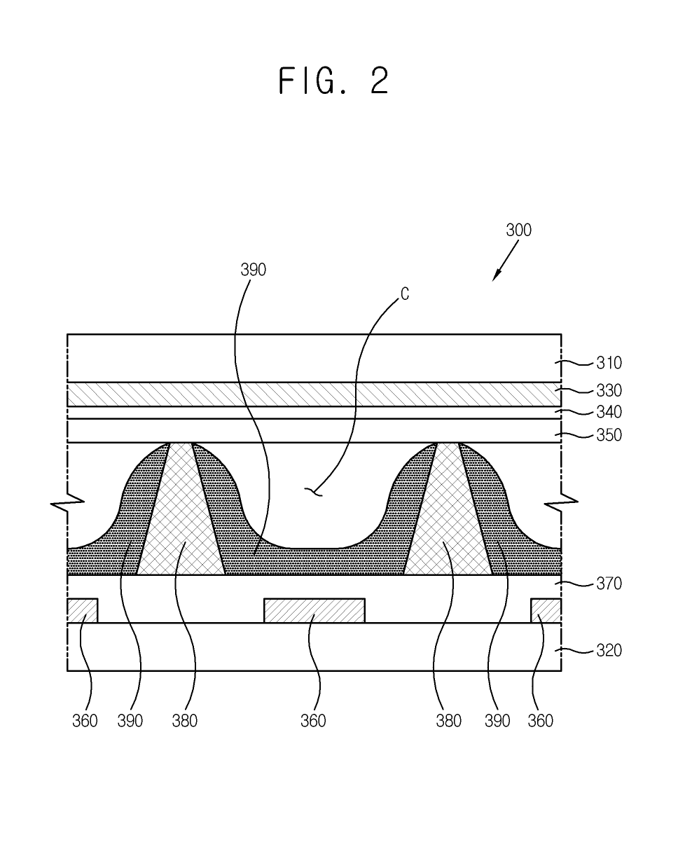

Hereinafter, a structure of the display panel 300 implemented as a PDP will be described with reference to FIG. 2.

FIG. 2 is a schematic sectional view of the display panel 300.

As shown therein, in the PDP 300, gas is injected between two electrodes installed in a sealed space, and a predetermined voltage is applied to the electrodes to create glow discharge. Then, ultraviolet rays generated during the glow discharge excite a fluorescent layer to form an image.

The PDP 300 may be classified into a direct current (DC) type and an alternating current (AC) type depending on a discharge mechanism. In the DC-PDP, electrodes are directly exposed to a gas layer sealed in discharge cells so that the voltage applied to the electrodes are directly applied to the discharge gas layer. In the AC-PDP, electrodes are separated by a discharge gas layer and a dielectric layer so that charged particles generated during the discharge do not absorb the electrodes and form a wall charge to cause a discharge.

In the PDP, a front substrate 310 and rear substrate 320 include a transparent material such as glass, and face each other to form a discharging space.

A stripe-type transparent electrode 330 is formed at predetermined intervals on the front substrate 310. In the transparent electrode 330, a stripe-type bus electrode 340 including a highly conductive material such as chrome or silver is formed to have a narrower width. The transparent electrode 330 and the bus electrode 340 are covered by the dielectric layer 350.

On the rear substrate 320, a stripe-type address electrode 360 is formed to be perpendicular to the transparent electrode 330 and the bus electrode 340. The address electrode 360 is covered by the dielectric layer 370.

On the dielectric layer 370, a plurality of barrier ribs 380 stands consecutively to form discharge cells C among the barrier ribs 380. A fluorescent layer 390 is formed in an internal wall extending from a lateral part to a bottom part of the barrier ribs 380 within the discharge cells C.

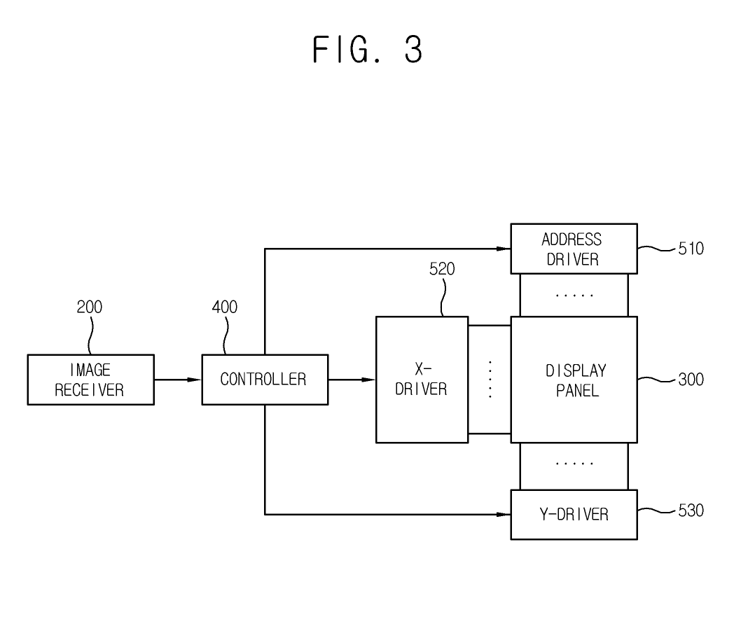

FIG. 3 is a block diagram of a driving structure for the display panel 300.

As shown therein, the display panel 300 includes an address driver 510 which generates an address pulse to control the discharge state of cells to be turned on and the discharge state after the turn-on, and an X-driver 520 and a Y-driver 530 which supply sustain voltages to cells, corresponding to an image signal, i.e., digital image data output by the image processor 200. The address pulse includes a write pulse and an erase pulse.

The controller 400 controls the address driver 510, X-driver 520, and Y-driver 530 to control the address information and the state of voltages supplied to each cell. The address information includes information of a location of cells to be turned on corresponding to the image data.

If the controller 400 is synchronized with a particular frame of the image data from the image processor 200 and drives the X-driver 520 and Y-driver 530, the X-driver 520 and Y-driver 530 supply the sustain voltage to electrodes of the cells.

If the controller 400 converts the image data into address information and provides the address driver 510 with the address information, the address driver 510 outputs write pulses and erase pulses at predetermined time intervals to cells to be turned on. At the time when a frame is started, the erase pulse is output to entire cells according to a reset signal and the remaining electric charge or electrons which remain due to the previous frame are erased. To adjust brightness, the controller 400 adjusts the number of the write pulses.

There are various methods of expressing a gray level of an image displayed on the display panel 300 by the controller 400. Address display separated (ADS) is a method of expressing a gray level of a single image frame by using the n number of sub-fields.

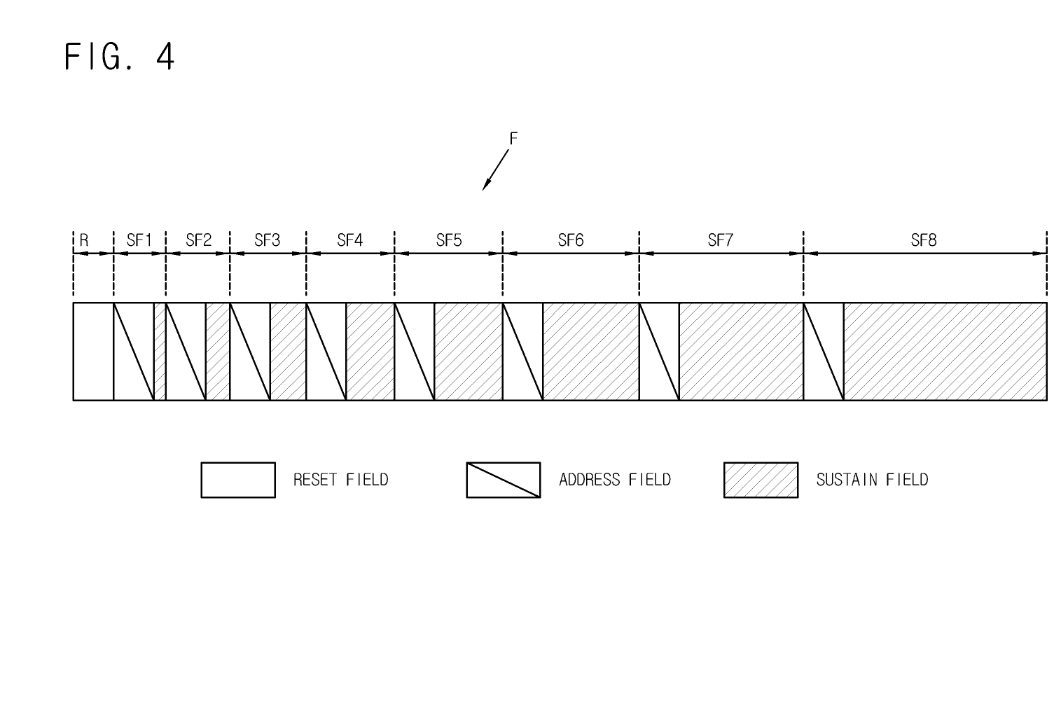

As a detailed example of the ADS, a method of expressing 256 gray levels by using 8 sub-fields will be described with reference to FIG. 4.

FIG. 4 illustrates an example of a method of expressing a gray level of a single image frame F by 8 sub-fields.

As shown therein, the time interval for displaying a single image frame F may be classified into sub-fields SF1 to SF8 including the n number of, e.g., 8 image information quantities or brightness levels.

The respective sub-fields SF1 to SF8 include an address field for designating pixels to be illuminated and a sustain field for sustaining luminance of the pixels designated in the address field in the display panel 300 corresponding to image data.

The sustain fields of the respective sub-fields SF1 to SF8 have different brightness levels, and this is expressed that the respective sub-fields SF1 to SF8 have different sub field weights.

For example, the respective sub-fields SF1 to SF8 have sub-field weights calculated by squaring (n−1) of 2 such as 1, 2, 4, 8, 16, 32, 64 and 128. The sum of weights of the respective sub-fields SF1 to SF8 in the image frame F is 256, and the gray level of the image frame F may be expressed by addressing any of the sub-fields SF1 to SF8. That is, the gray level or gray scale of the image frame F is expressed as an integrated quantity of brightness level expressed by the sub-fields SF1 to SF8 of the image frame F.

For example, if the gray level of the image frame F is 3, the controller 400 selects and addresses SF1 and SF3 of the sub-fields SF1 to SF8. If the gray level of the image frame F is 127, the controller 400 selects and addresses SF1 to SF7 of the sub-fields SF1 to SF8. If the gray level of the image frame F is 256, the controller 400 addresses all of the sub-fields SF1 to SF8.

However, if the image frame F is displayed on the display panel 300 in the above manner, there are remaining electrons which have not been used in displaying the image on the display panel 300. The remaining electrons damage an image quality or cause deterioration when a next image frame F is displayed.

Accordingly, the controller 400 applies a high voltage to the entire display panel 300 at predetermined intervals and generates light during a short time and discharges the display panel 300 to remove the remaining electrons. This is called a reset operation, and the time period during which the reset operation is performed is called a reset period.

The interval of performing the reset period may vary, and the reset operation may precede the sub-fields SF1 to SF8 of the image frame F whenever the image frame F is displayed. Otherwise, the reset operation may be performed at an interval of a predetermined number of frames F or at every sub-field SF1 to SF8.

However, due to the characteristics of the reset operation which discharges the entire display panel 300, bright light is emitted across the display panel 300 during the reset period. This is called background luminance, and if the image frame F displayed on the display panel 300 is a relatively dark, low gray scale image, a user may recognize a dark area of the image as a gray color due to the background luminance.

That is, a difference between a brighter area and a darker area in an image is expressed to be relatively small due to the background luminance, and a contrast ratio of the image is decreased.

In consideration of the above problem, a following method is provided according to the exemplary embodiment.

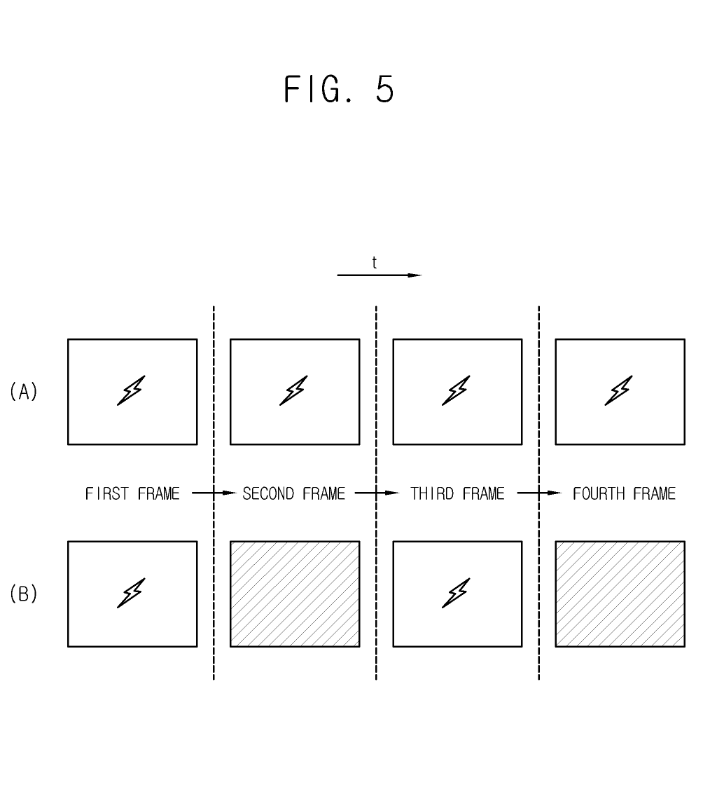

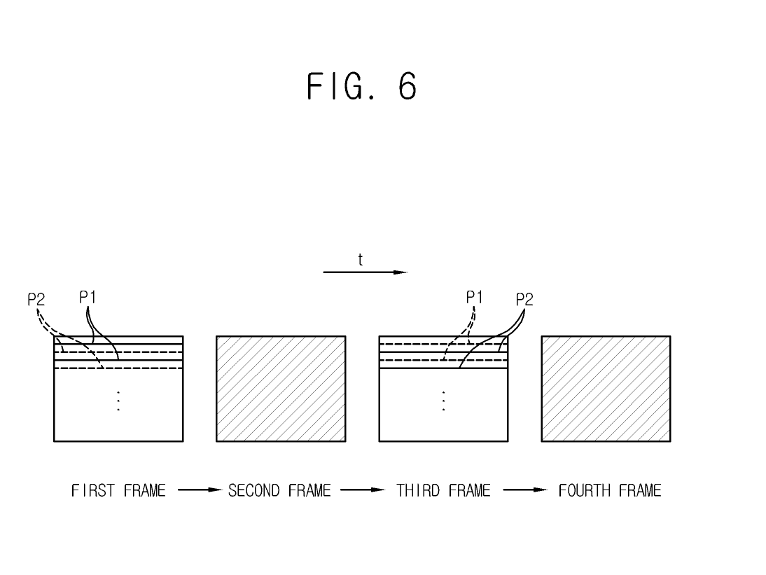

FIGS. 5 and 6 are examples of a method of performing the reset operation while an image is displayed.

As shown in FIG. 5, the display apparatus 1 displays an image on the display panel 300. The image is displayed on the display panel 300 on a frame by frame basis as time t passes.

If a first frame, a second frame, a third frame and a fourth frame of the image are sequentially displayed, the display apparatus 1 analyzes image information quantity included in the image frame displayed in real-time to determine the image information quantity of the image frame.

The image information quantity of the image frame is provided to quantitatively measure which image frame includes image information/image information at a certain level. For example, the image information quantity may be an average picture level (APL) of the image frame or a brightness level or gray level of the image frame.

The APL is decided by calculating an average of image signal levels in a period in which a valid image portion of each horizontal scanning line is present, during a single image frame period. The APL indicates a difference between a blanking level and a reference white level as a percentage, wherein the blanking level is expressed as 0 institute of radio engineers (IRE) and the reference white level is expressed as 100 IRE.

If the image information quantity of the image frame is relatively high or larger than a preset level, the image frame is a high gray scale image with a relatively high brightness. If the image information quantity of the image frame is relatively low or smaller than the preset level, the image frame is a low gray scale image with relatively low brightness.

The display apparatus 1 may determine that the image information quantity of the image frame displayed in real-time is large, e.g., higher than a preset first level. In this case, the display apparatus 1 performs the reset operation with respect to the entire display panel 300 at an interval of a single frame, i.e. at every frame as in (A) in FIG. 5. The first level may be decided as various figures at the design phase of the display apparatus 1 and is not limited to a particular figure.

If the reset operation is performed as above, the remaining electrons are removed from the display panel 300 and a distortion of the next image frame may be prevented. However, the reset operation which is performed at a short interval is a cause of the background luminance as explained above.

The background luminance is not significant with respect to a high gray scale image for a user. However, in the case of a low gray scale image, a contrast ratio of the low gray scale image is decreased due to the background luminance, and the image quality is damaged.

Accordingly, if it is determined that the image information quantity of the image frame is relatively small, e.g., lower than the first level, the display apparatus 1 adjusts the reset period to be longer than a default period as in (A) in FIG. 5. For example, as in (B) in FIG. 5, the display apparatus 1 may perform the reset operation with respect to the entire display panel 300 at an interval of two frames. Of course, the frame interval may be set differently depending on an exemplary type of the display apparatus 1.

As shown in FIG. 5, the display apparatus 1 performs the reset operation at a timing of the first frame, and skips the reset operation at a timing of a second frame. The display apparatus 1 performs the reset operation at a timing of a next third frame, and skips the reset operation at a timing of a fourth frame. In the case of a low gray scale image, the cells addressed by the display panel 300 are relatively small, and even if the reset period is extended unlike in the case of a high gray scale image, deterioration of the image may be minimized.

According to the present exemplary embodiment, the display apparatus 1 adjusts the interval of the reset operation with respect to the display panel 300 according to the image information quantity of the image frame to thereby reduce the decrease in the contrast ratio of the low gray scale image.

However, if the interval of the reset operation is extended, the background luminance may be reduced, but the image deterioration increases. Thus, extending the interval of the reset operation beyond a certain limit is not possible.

The display apparatus 1 may determine that the image information quantity of the image frame is smaller than that in FIG. 5, i.e., determine that the image is a particularly dark image among low gray scale images. For example, while a second level which is lower than the first level has been set, the display apparatus 1 may determine that the image information quantity of the image frame is lower than the second level.

The second level may vary like the first level, and is not limited to a particular figure except that it is lower than the first level. For example, an image frame, image information quantity of which is higher than the first level, is a relatively bright, high gray scale image. An image frame, image information quantity of which is lower than the first level and higher than the second level, is a relatively dark, low gray scale image.

The reset method for the case where the display apparatus 1 determines that the image frame is a relatively dark, low gray scale image, will be described with reference to FIG. 6.

As shown in FIG. 6, if a first frame, a second frame, a third frame and a fourth frame of an image are sequentially displayed, the display apparatus 1 analyzes the image information quantity of the image frame displayed in real-time to determine the image information quantity of the image frame.

If it is determined that the image information quantity of the image frame is lower than the second level, the display apparatus 1 determines the reset period. According to the present exemplary embodiment, the display apparatus 1 may set the reset period to be equal to the case in the exemplary embodiment in (B) in FIG. 5. That is, the display apparatus 1 performs the reset operation at the timing of the first and third frames, and skips the reset operation at the timing of the second and fourth frames.

In performing the reset operation, the display apparatus 1 divides the entire display area of the display panel 300 into a plurality of areas. The display apparatus 1 sequentially discharges the plurality of divided display areas at a preset interval to perform the reset operation.

If the display panel 300 is divided into two areas of a first area and a second area, the display apparatus 1 discharges the first area of the display panel 300 and does not discharge the second area at the timing of the first frame. Then, the display apparatus 1 does not discharge the first area of the display panel 300 and discharges the second area thereof at the timing of the third frame.

The display apparatus 1 sequentially discharges respective areas forming the entire display area of the display panel 300 at the reset interval, and has the effect of extending the reset period without extending the reset period practically. Then, the background luminance is minimized and an image with an improved contrast ratio may be provided to a user.

The method of dividing the display panel 300 into a plurality of areas and the number of divided areas may be decided variously, and do not limit the spirit of the exemplary embodiments.

For example, the display apparatus 1 may divide the display panel 300 into the first and second areas, but the first area may include a horizontal pixel line P1 in odd lines of the display panel 300, and a horizontal pixel line P2 in even lines of the display panel 300.

Then, the display apparatus 1 discharges the horizontal pixel line P1 in odd lines, and does not discharge the horizontal pixel line P2 in even lines at the timing of the first frame. The display apparatus 1 does not discharge the horizontal pixel line P1 in odd lines and discharges the horizontal pixel line P2 in even lines at the timing of the third frame.

If the display panel 300 is divided into three areas, the display apparatus 1 may classify the first to third horizontal pixel lines as a first area; fourth to sixth horizontal pixel lines as a second area; seventh to ninth horizontal pixel lines as a third area; and tenth to twelfth horizontal pixel lines as the first area. Otherwise, the display apparatus 1 may classify the first horizontal pixel line as a first area; a second horizontal pixel line as a second area; a third horizontal pixel line as a third area; a fourth horizontal pixel line as the first area; and a fifth horizontal pixel line as the second area.

Otherwise, the display apparatus 1 may divide each area of the display panel 300 into an area having predetermined horizontal and vertical areas instead of horizontal pixel lines of the display panel 300.

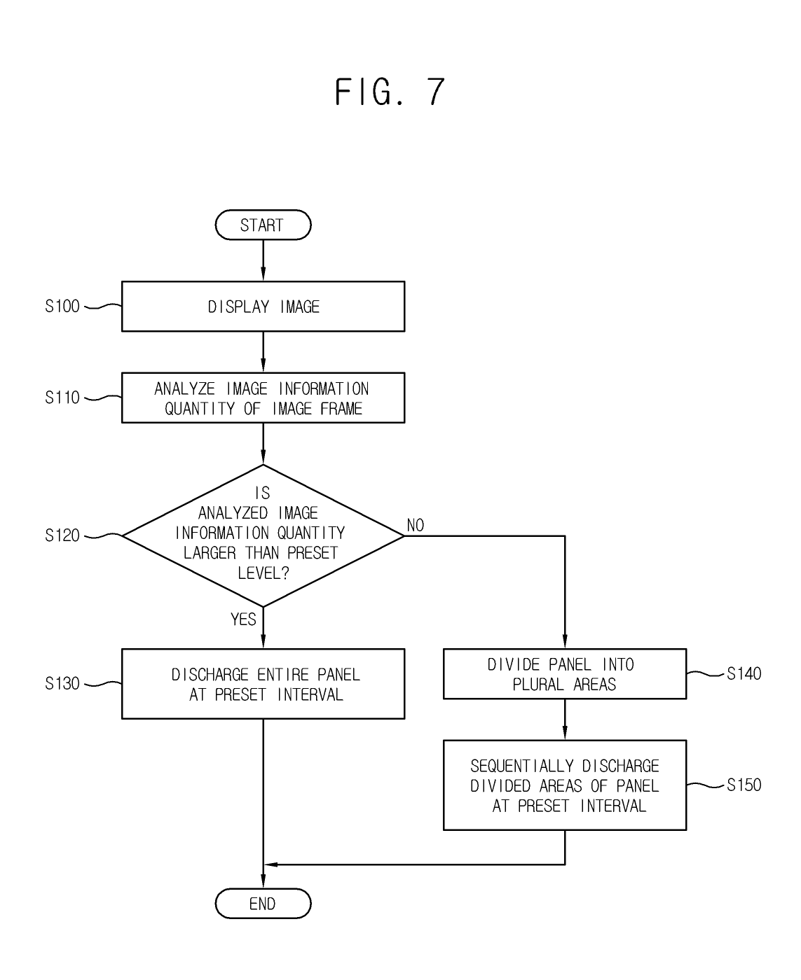

Hereinafter, a control method of the display apparatus 1 according to the present exemplary embodiment will be described with reference to FIG. 7.

FIG. 7 is a control flowchart of the control method of the display apparatus 1.

As shown therein, the display apparatus 1 processes an image signal and displays an image on the display panel 300 based on the processed image signal (operation S100). While the image is displayed, the display apparatus 1 analyzes the image information quantity of the image frame in real-time (operation S110).

The display apparatus 1 determines whether the image information quantity of the image frame is larger than the preset level (operation S120).

If it is determined that the image information quantity of the image frame is larger than the preset level, the display apparatus 1 performs the first reset operation to discharge the entire display apparatus 300 at a preset interval (operation S130).

If it is determined that the image information quantity of the image frame is not larger than the preset level, the display apparatus 1 divides the display panel 300 into a plurality of areas (operation S140). The display apparatus 1 performs the second reset operation to sequentially discharge the divided areas of the display panel 300 at a preset interval (operation S150). The interval of the first and second reset operations may be equal or different, and may vary depending on an operation type of the display apparatus 1.

Accordingly, the display apparatus 1 may reduce the background luminance occurring from the self-luminous display panel 300 implemented as a PDP, and provide a user with an image having an improved contrast ratio.

In the foregoing exemplary embodiment, the display panel 300 includes the PDP, but is not limited thereto. The spirit of the exemplary embodiments may also apply to various types of self-luminous display panels, including organic light emitting diodes (OLEDs), which may control digital driving.

Although a few exemplary embodiments have been shown and described, it will be appreciated by those skilled in the art that changes may be made in these exemplary embodiments without departing from the principles and spirit of the exemplary embodiments, the range of which is defined in the appended claims and their equivalents.

What is claimed is:

1. A display apparatus comprising:
a self-luminous display panel;
an image processor configured to process an image signal and display an image on the display panel based on the processed image signal; and
a controller configured to perform a reset operation which removes remaining electrons from the display panel by discharging the display panel at a preset interval while the image is displayed, and selectively perform a first reset operation and a second reset operation based on image information quantity of frames of the image displayed on the display panel, wherein the first reset operation is performed to discharge the entire display panel at the preset interval, and the second reset operation is performed to sequentially discharge divided areas of the display panel, at the preset interval.

2. The display apparatus of claim 1, wherein the controller is configured to select one of the first reset operation and the second reset operation based on the image information quantity of a frame that is displayed in real-time.

3. The display apparatus of claim 2, wherein the controller is configured to select the first reset operation if the image information quantity of the frame is higher than a preset level, and select the second reset operation if the image information quantity of the frame is lower than the preset level.

4. The display apparatus of claim 3, wherein the image information quantity of the frame comprises an average picture level (APL) of the frame.

5. The display apparatus of claim 1, wherein the controller is configured to divide the display panel into units of horizontal pixel lines of the display panel.

6. The display apparatus of claim 5, wherein the controller is configured to classify the display panel into a first area comprising the horizontal pixel lines in odd lines, and a second area comprising the horizontal pixel lines in even lines, and sequentially discharges the first and second areas when performing the second reset operation.

7. The display apparatus of claim 1, wherein the controller is configured to adjust the preset interval for performing the first reset operation based on the image information quantity of the frame.

8. The display apparatus of claim 7, wherein the controller is configured to perform the second reset operation if the image information quantity is smaller than a preset level, and extend the preset interval and perform the first reset operation if the image information quantity is larger than the preset level.

9. The display apparatus of claim 1, wherein the display panel comprises a plasma display panel (PDP).

10. A control method of a display apparatus comprising a self-luminous display panel, the control method comprising:
processing an image signal and displaying an image on the display panel based on the processed image signal;
performing a reset operation for removing remaining electrons from the display panel by discharging the display panel at a preset interval while the image is displayed;
wherein the performing the reset operation comprises selectively performing one of a first reset operation and a second reset operation based on image information quantity of frames of the image displayed on the display panel, wherein the first reset operation discharges the entire display panel at the preset interval, and the second reset operation sequentially discharges divided areas, into which the display panel is divided, at the preset interval.

11. The control method of claim 10, wherein the selectively performing one of the first reset operation and the second reset operation comprises selecting one of the first reset operation and second reset operation based on the image information quantity of a frame that is displayed in real-time.

12. The control method of claim 11, wherein the selectively performing one of the first reset operation and second reset operation comprises selecting the first reset operation if the image information quantity of the frame is higher than a preset level, and selecting the second reset operation if the image information quantity of the frame is lower than the preset level.

13. The control method of claim 12, wherein the image information quantity of the frame comprises an average picture level (APL) of the frame.

14. The control method of claim 10, wherein the selectively performing one of the first reset operation and second reset operation comprises dividing the display panel into units of horizontal pixel lines of the display panel.

15. The control method of claim 14, wherein the dividing the display panel into the units of horizontal pixel lines of the display panel comprises classifying the display panel into a first area comprising horizontal pixel lines in odd lines, and a second area comprising horizontal pixel lines in even lines; and sequentially discharging the first and second areas when performing the second reset operation.

16. The control method of claim 14, wherein the dividing the display panel into the units of horizontal pixel lines of the display panel comprises adjusting the preset interval for performing the first reset operation based on the image information quantity of the frame.

17. The control method of claim 16, wherein the dividing the display panel into the units of horizontal pixel lines of the display panel further comprises performing the second reset operation if the image information quantity is smaller than a preset level, and the adjusting the preset interval for performing the first reset operation comprises extending the interval and performing the first reset operation if the image information quantity is larger than the preset level.

18. The control method of claim 10, wherein the display panel comprises a plasma display device (PDP).

19. A display apparatus comprising:
a self-luminous display panel;
an image processor configured to process an image signal and display an image on the display panel based on the processed image signal; and
a controller configured to analyze image information quantity of a frame of the image displayed in real-time, discharge the entire display panel at a predetermined interval to reset remaining electrons of the display panel if it is determined that the image information quantity of the frame is larger than a preset level, and sequentially discharge a plurality of display areas of the display panel at the predetermined interval, and does not discharge the entire display panel if it is determined that the image information quantity is smaller than the preset level.

20. The display apparatus according to claim 19, wherein the display panel comprises a plasma display device (PDP).

21. A control method of a display apparatus comprising a self-luminous display panel, the control method comprising:
processing a received image signal and displaying the received image on the display panel based on the processed image signal;
determining an average picture level (APL) of image frames of the received image; and
if the APL is higher than a preset level, performing a reset operation to discharge the entire display panel, and if the APL is lower than the preset level, performing the reset operation to discharge the entire display panel at an interval of a predetermined number of frames.
